(19) United States
(12) Patent Application Publication
(10) Pub. No.: US 2012/0270025 A1
(43) Pub. Date: Oct. 25, 2012

(54) Reinforced Material

(76) Inventor: Stephen John Russell, Harrogate (GB)

(21) Appl. No.: 12/918,763

(22) PCT Filed: Feb. 20, 2009
(86) PCT No.: PCT/GB09/00500

§ 371 Date: Nov. 4, 2010

(30) Foreign Application Priority Data
Feb. 22, 2008 (GB) 0803277.3

(51) Int. Cl. D04H 13/00; B32B 7/08

(52) U.S. Cl. 428/219; 442/1; 156/93; 156/60

(57) ABSTRACT

There is described a reinforced fibrous material including two nonwoven fabric layers entangled with each other and with a metallic mesh layer disposed there between, and methods for its preparation and uses thereof.

### FIELD OF THE INVENTION

The present invention relates to a novel form of reinforced fibrous material and to methods of its preparation and use thereof.

More particularly, the present invention relates to the use of the novel reinforced material as an intrusion resistant roller blind. The term intrusion resistant is intended to included slash resistant and optionally, heat resistant or flame retardant.

### BACKGROUND OF THE INVENTION

At present, when any area, for example a cabinet, shelving or kiosk, whether it be used for tobacco sales, alcohol or other retail products, bank service desks etc. requires a restrictive, preventative or secure barrier to deny access, a shutter type screen is used. Usually, this is a screened barrier made up of horizontally mounted interconnected metal laths or slats. Such a lathed screen runs between two vertical guides either side. The lathed screen slides within the guides and rolls up and around a sprung roller inside the box unit when not in use and is pulled down to create a complete barrier and locked into place at the bottom. These types of shutter barriers come in all shapes and sizes, but are primarily made of different grades of plastics, aluminum and other metals, depending on the level of security required.

The problem with these types of barrier is that they are bulky, heavy, thick, difficult to fit and expensive to produce. They also contain many components that are easily damaged during transit, and the lathes can become miss-aligned. These particular lathed barriers also create a very negative impression, for example, when used internally in areas such as cafeterias, which require securing during closing hours, since they can be deemed to display a lack of trust of in-house staff or employees. Lathed barriers are also difficult to conform or mould around complex shapes that may extend from within the enclosed space because of their rigidity.

Therefore, there is a need for a softer, less hostile approach for areas such as this.

Furthermore, the price of materials, for example, metals, such as aluminum is increasing substantially and therefore there is a customer demand for alternative materials which may be less expensive and/or offer new designs, without compromising the structural integrity and/or security or indeed offering the possibility of providing a higher level of security.

Thus, US Patent Application No. 2003/176,129 describes a fabric comprising elongated steel elements is provided. This fabric is to be used to provide cut-resistance or reinforcement for protective textiles. Elongated steel elements are in contact relationship, so improving the resistance to knife cutting actions.

U.S. Pat. No. 5,545,470 describes an anti-vandalism layer, especially for application in vehicle seats, vehicle roofs, vehicle tarpaulins, tents, inflatable structures, wall facing, and similar objects having an incisible exterior layer and subject to vandalism, includes of a knit fabric having at least in part cut-resistant fibres such as aromatic polyamide fibres, gel-spun polyethylene fibres, or glass fibres is disclosed. In at least one thread system, the knit fabric contains a wire present in a thread system projecting from the surface of the knit fabric such that during subsequent gluing of the anti-vandalism layer to, for example, a textile flat structure, gluing tends to occur on this thread system.

U.S. Pat. No. 5,770,530 describes a protective layer, in particular an anti-vandalism protective layer, for car seats, car roofs, convertible tops, car tarpaulins, tents, supporting air parts, wall linings, shatter-proof walls, and bullet-proof vests is comprised of a cover layer, a cut resisting material layer of cut resisting fibres, such as aromatic polyamide fibres, polyethylene fibres spun by the gel-spin process or glass fibres, a sheathed wire of a diameter of 0.1 to 2 mm contained in a threads which protrude out of the plane of the cut resisting layer and toward the cover layer, and a textile nonwoven layer applied to one side of the cut resisting material layer by needling and then attached to the cover layer by adhesive bonding.

UK Patent application No. 2385823 describes flexible barrier which comprises a laminated sheet material which comprises a plurality of intersecting pockets and is provided with a cut resistant wire rope or cable meandering through the pockets. However, such barriers suffer from the disadvantage that, inter alia, due to the use of adhesives in the lamination, they are stiffer and less flexible. Furthermore, they may be less breathable, are more dense and may suffer from delamination. Delamination is particularly a problem when dealing with a reinforced material that is intended, in use, to be rolled or flexed.

### SUMMARY OF THE INVENTION

Thus, there is a need for a reinforced intrusion resistant barrier material which overcomes or mitigates the problems of the prior art fabrics.

Therefore, according to a first aspect of the invention we provide a reinforced fibrous material which comprises one or more nonwoven fabric layers entangled with one or more metallic mesh layers.

Thus, the one or more metallic mesh layers will comprise an arrangement of interlocking metal links or wires, which may be knitted or woven, with substantially evenly spaced and substantially uniform openings in between the interlocking metal links. When a nonwoven layer is provided either side of the mesh layer, fibres from one or both of the nonwoven fabric layers are entangled between the openings of the mesh creating physical interconnections between the nonwoven layers.

In use, the material may be un-rolled out of a casing and may be secured to a fixed plane at its extended point. Thus, the un-rolled material is adapted to create a seal on all sides, therefore providing a secure barrier capable of denying complete access to the area secured. Preferably, the material is adapted to be securely fixed to an area that when the material un-rolled. Furthermore, the material may incorporate one or more locking members. Indeed a further advantage of the materials of the present invention is that because the materials are approximately isotropic in terms of fibre orientation, the materials of the present invention generally do not have differential stretch behaviour according to the direction of applied uniaxial stress and can therefore by integrated within a roller blind type of arrangement in different fabric orientations.

The materials of the invention are cut- or slash- or vandal-resistant. Such materials have a high tear strength and high tear resistance and resist tear propagation should the material be penetrated by a sharp object such as a knife. It will be understood by a person skilled in the art that cut or stab resistant material may not necessarily be slash resistant. By the term “slash” we mean to cut with a sweeping stroke. Slash resistant materials can be measured according to The (UK) Home Office Scientific Development Branch Slash Resistance Standard for UK Police (2006) 48-05. This standard uses a test method which comprises the use of an assembly that enables a slash missile, e.g. a knife or other blade or sharp object, to fall under the influence of gravity and contact a slash panel at a predetermined point on a force table mounted at 2° from vertical. The (UK) Home Office Scientific Development Branch Slash Resistance Standard for UK Police (2006) 48-05 is publically available and may therefore be considered to be common general knowledge.

The nonwoven fabric layer of the reinforced material of the invention preferably comprises a relatively thin entangled, e.g. hydroentangled, nonwoven fabric produced from either continuous filaments, staple fibres or a mixture thereof. In the reinforced material the fabric is preferentially a multilayer fabric that is integrated by mechanical entanglement of fibres in each layer and mechanically interconnected between each layer without the use of adhesives comprising, for example, first and second layers of nonwoven fabric and a mesh layer in between the first and second nonwoven fabric layers. In such a material the first and second layers of nonwoven fabric may be of the same composition or construction or different. Preferably they are the same. Furthermore, one or both of the nonwoven fabric layers may be entangled with the mesh layer. In a preferred embodiment both nonwoven fabric layers are entangled with the mesh layer. Further, the layers either side of the mesh may be interconnected by entanglement, e.g. hydroentanglement, in the openings between the solid regions, e.g. the metal links or wires, in the mesh. The method of entanglement may vary depending upon, inter alia, the nature of the nonwoven fabric, the thickness of the fabric, its fibre composition, etc. However, the method of entanglement may be such that it produces a material in which the layers are interconnected, e.g. randomly or non-continuously interconnected. Thus, when the reinforced material comprises first and second layers of nonwoven fabric and a mesh layer, as hereinbefore described, the nonwoven fabric layers may be interconnected or entangled with the mesh layer and also interconnected or entangled with each other. Such entanglement may be substantially at the surface of the respective nonwoven fabric layers or may, depending upon the method of entanglement, thickness of the fabric, fibre composition and dimensions, etc, be entangled or interconnected deep within the fabric layers.

To achieve acceptable levels of protection against mechanical threats such as slashing of the material, each fabric layer of the material is ideally an entangled nonwoven fabric having a fabric weight of from 20 to 1000 gm⁻². However, one advantage of the reinforced material of the present invention is that it may be produced in lightweight or thin materials when compared to prior art processes. For example, in the methods employed for laminating fabrics, the individual fabric layers must initially be self supporting since they must be pre-assembled, wound up, unwound and formed into a multilayered laminate via a sequence of processes. However, in the entanglement methods of the present invention, each layer, e.g. each fabric layer, may be lightweight and assembled while the layer is substantially unbonded and thus may have a weight of from 20 to 150 gm⁻², preferably from 20 to 100 gm⁻² and more preferably from 20 to 60 gm⁻². Strengthening of each layer and entanglement of each layer to other layers including the mesh layer, can therefore take place simultaneously in a one-step process.

The nonwoven fabrics of the present invention may comprise any conventionally known nonwoven fabrics. However, desirably the nonwoven fabric comprises a high modulus and high temperature-resistant fibrous material that offers further resistance to a knife or blade or other sharp object. Thus for example, a nonwoven fabric may comprise entangled p-phenylene terephthalamide (PPTA or para-aramid) fibres, e.g. Kevlar® and Twaron®. Alternatively, fabrics may comprise of PPTA fibres blended with other fibres, such as, poly-metaphenylene isophthalamide (MPIA or meta-aramid) fibres, e.g. Nomex®. Recycled or recovered fibres of these compositions are also suitable depending on their physical properties post-extraction. Where heat resistance is not necessary, ultra high molecular weight polyethylene (UHMWPE) fibres, high modulus polyethylene (HMPE) or high performance polyethylene (HPPE) fibres including blends with MPIA and/or PPTA respectively, may be selected. Staple fibres may be converted into fibrous webs by carding; by carding and cross-lapping; by air-laying or by combinations of these processes prior to entanglement to form the reinforced fibrous material. Alternatively, continuous filaments may be converted into nonwoven webs by spunlaid formation (i.e. direct extrusion into a web) followed by entanglement to form the reinforced fibrous material. Each layer of fabric may also be produced by layering the same or different pre-formed webs or pre-bonded nonwoven fabrics to make a composite construction that is then mechanically joined in the material of the invention by entanglement.

In a further embodiment, a layer of one or more nonwoven fabrics, e.g. containing PPTA fibres, may be combined with a layer of nonwoven fabric of lower density than the first layer.

A variety of components may be used in the nonwoven fabric layers of the invention, examples of which are natural fibres such as pulp fibres, cotton, jute, wool, recycled fibre and hair fibres etc., man-made fibres or filaments, e.g. polyester, viscose rayon, nylon, polypropylene, polyethylene and the like, pulp fibres or mixtures of pulp fibres and staple fibres, aramid fibres, e.g. Kevlar® or Twaron®; and mixtures of any of the aforesaid. However, in a preferred embodiment of the invention the, components comprise one or more of PPTA fibres, MPIA fibres, UHMWPE fibres or blends thereof. In order to produce an intrusion resistant material that is heat resistant and/or flame retardant, as well as capable of protecting against slashing, the material may be composed of one or more entangled nonwoven fabric layers containing MPIA and PPTA aramid fibres that are entangled to one or both sides of a metal mesh of woven, knitted or laid-up filament construction without the use of binder chemicals. Where entanglement involves two layers each entangled to opposite sides of the mesh, the two layers may be interconnected by entanglement between the openings in the mesh layer. Preferably, the entangled aramid fabric is composed of at least one layer of PPTA fibres (e.g. Kevlar® or Twaron®) or a blend of PPTA fibres and MPIA fibres (e.g. Nomex®).

The length of the staple fibres used in the nonwoven fabric in the material of the invention may vary and may be those conventionally used in nonwoven fabrics, e.g. from 3 to 100 mm, which is principally determined by the selection of the web formation process.

As hereinbefore described, in the intrusion resistant material the nonwoven fabric may be entangled to one or both sides of one or more layers of flexible metal mesh of woven, knitted or laid-up filament construction. Although a variety of metal meshes may be used according to the invention, a preferred metal mesh may comprise one or more alloys or may comprise an annealed high tensile steel or stainless steel. Preferably, the metal wire is annealed and hardened and consists of from 1 to 4 filaments of wire per thread comprising the mesh. Knitted metal meshes are particularly preferred because of their ability to deform and gather in tension. The diameter of the thread of the metal mesh may vary but may be from 0.1 to 1.0 mm, preferably from 0.2 to 0.8 mm and more preferably from 0.28 to 0.5 mm. One or more meshes may be incorporated within the intrusion resistant material of the invention.

In a further aspect of the invention one or more of the exposed outer layers of the reinforced material may be attached to a protective film layer, which may be additionally coloured or printed with logos, text or images including advertising messages including ambient media. When present, the protective film layer protects the secure material from agencies of wear and degradation during use caused by for example, exposure to ultra-violet light and sunlight (particularly necessary in the case of aramid fibre compositions), washing with cleaning fluids and detergents, dirt accumulation, abrasion, rubbing and accidental spillages. Additionally, the protective film layer may be flame retardant and/or provide a degree of additional mechanical protection. Additionally, the protective film layer may comprise a hydrophilic membrane or coating to mediate moisture vapour transmission.

An especially preferred embodiment of the invention initially comprises a sandwich construction. Thus, for example, a secure web or nonwoven fabric, e.g. an entangled PPTA fibre such as Kevlar®, fabric; wire mesh; and a second secure web or nonwoven fabric, e.g. an entangled PPTA fibre, such as Kevlar®, fabric, may be entangled together to produce a structure in which the surfaces of each discrete layer in the initial sandwich become fully interconnected, producing a structure in which fibres in the first and second fabric layers are entangled together around the embedded metal wire mesh. Preferably, the layers are hydroentangled together. This is advantageous, in that, inter alia, fibres may be mechanically bonded by entwining around other fibres and interconnected by entangling through and/or around, the wire mesh. Where a second fibrous layer is present on the reverse side of the metal mesh, fibres may be connected by entanglement through the mesh openings. Hydroentanglement produces a fibrous outer surface(s), which aids lamination with a protective film layer. Thus, it is an important distinction that when the reinforced intrusion resistant material of the present invention comprises, a plurality of layers, e.g. three layers (fabric:mesh:fabric), as hereinbefore described, the material will generally not comprise discrete layers rather they will be diffused entangled layers at least at their interfaces.

Furthermore, if the fabric and/or mesh layers are entangled together only at the edges or in discrete regions, e.g. discontinuously, the penetration resistance during the slash test can improve even more. Thus, for example, such an arrangement may allow for some slippage between layers to take place. Slippage of fibres between the layers and/or trapping of the blade due to bunching of the fibres around the blade, if it has penetrated the material, can be valuable in preventing the propagation of a tear.

In a further embodiment, two fire-retardant apertured polymeric films may be entangled to either side of a metal mesh. In such material, the metal mesh and entire composite material construction must be sufficiently flexible and thin to be tightly wound around the small diameter roller of a blind. The material must also be capable of fitting and sliding in the roller blind guide.

The material of the invention is advantageous in that, inter alia, it is more moisture breathable, less stiff, more flexible and does not delaminate as readily as conventionally known bathers. Since conventional lamination is obviated by entanglement, no adhesive binders are required and there is a reduced risk of delamination of the reinforced material at elevated temperatures.

The entanglement or interconnection comprises mechanically entangling the nonwoven fabric layer(s) to the metal mesh together.

According to further aspect of the invention we provide a method of manufacturing a reinforced material as hereinbefore described which comprises entangling one or more nonwoven fabric layers with at least one metal mesh layer.

The entanglement process may comprise any such process known per se. Thus, the entanglement or interconnection may comprise steam or hot fluid jet entangling the nonwoven layer with the mesh layer. However, a preferred method of entanglement is mechanical entanglement. Such mechanical entanglement may comprise, for example, needle punching. The most preferred method of entanglement is hydroentanglement. When the method of the invention comprises entangling more than one nonwoven fabric layer, it is within the scope of the present invention to comprise a combination of entanglement methods as hereinbefore described.

Hydroentanglement is ideally carried out using multiple injectors or manifolds in sequence with water jet pressures of, for example, from 40 to 400 bar (4 MPa to 40 MPa). Nozzle diameters of from 80 to 140 microns are preferred.

Although the reinforced material of the invention may have a variety of uses, due, inter alia, to its improved flexibility over conventionally known barriers, it is especially useful in the manufacture of an intrusion resistant, i.e. slash proof, roller blind assembly. Thus, according to a further aspect of the invention we provide an intrusion resistant roller blind which comprises a reinforced material as hereinbefore described.

According to a yet further aspect of the invention we also provide a method of securing a casing which comprises fitting a roller blind assembly comprising a roller blind comprising an intrusion resistant material attached to a rail.

In a yet further aspect of the invention we provide an intrusion resistant blind assembly kit comprising a roller blind comprising an intrusion resistant material, a casing and a rails adapted for attaching to the roller blind.

### DETAILED DESCRIPTION OF THE INVENTION

The invention will now be described solely by way of example and with reference to the accompanying drawings in which;

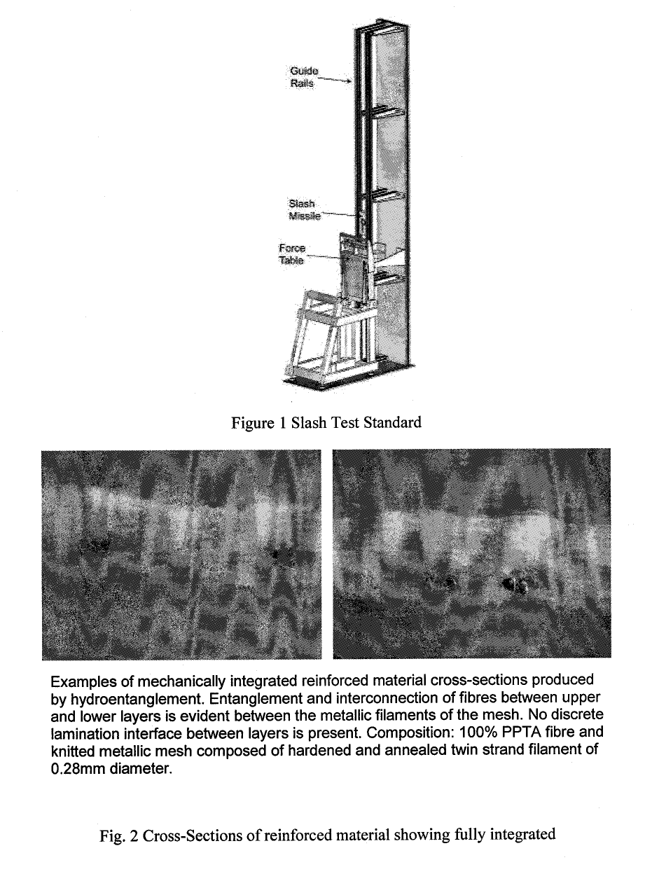

FIG. 1 is an illustration of an HOSDB designed guided drop assembly; and

FIGS. 2a and 2b are examples of entangled, integrated reinforced material in cross-section produced by hydroentanglement.

From FIGS. 2a and 2b entanglement and interconnection of fibres between the upper and lower layers is evident between the metallic threads of the knitted mesh. No discrete lamination interface between layers is present.

Two carded and cross-lapped webs were prepared from 100% PPTA fibres and fed either side of a knitted metallic mesh composed of hardened and annealed twin strand filament of 0.28 mm diameter. After prewetting to evacuate air in the fibrous layers, the three layer construct was hydroentangled using 5 injectors with a water jet pressure profile in which the maximum pressure was 220 bar (2.2 MPa). The fabric was dried in a through-air dryer.

Fabric stiffness can be determined using methods described in ASTM D5732-95, ASTM D1197-97, WSP and ITS 90.1 (EDANA-INDA) and BS EN ISO 9073-7:1998, BS 3356:1990.

### EXAMPLE 1

Intrusion resistant fabrics were tested in accordance with the HOSDB Slash Resistance Standard for UK Police (2006), Publication No. 48/05 (incorporated herein by reference).

Testing was performed using the HOSDB designed guided drop assembly, shown in FIG. 1 at an external independent facility. This assembly enables the slash missile to fall under the influence of gravity and contact the slash panel at a predetermined point on a force table mounted at 2° from vertical. Details of the setup and calibration of the test equipment used for certification testing at HOSDB approved test facilities given in Appendix A of HOSDB Slash Resistance Standard for UK Police (2006), Publication No. 48/05. Examples of test data obtained using fabrics produced in accordance with the present invention using different process conditions are listed in Table 1a. Reference data obtained for fabrics produced without the use of a knitted wire mesh are shown in Table 1b.

TABLE 1a
Intrusion resistant fabric data tested in accordance
with the HOSDB Slash Resistance Standard for UK
Police (2006), Publication No. 48/05.

| | Force |
|---|---|
| Secure fabric construction | (N) |
| Mesh + 180 g/m² hydroentangled UHMWPE (Dyneema ®) | 67.5 |
| fibre | |
| Mesh + 180 g/m² hydroentangled UHMWPE (Dyneema ®) | 88.0 |
| Mesh + 180 g/m² hydroentangled UHMWPE (Dyneema ®) | 94.7 |
| Mesh + 150 g/m² hydroentangled para-aramid (Kevlar ®) | 103.0 |
| Mesh + 160 g/m² needlepunched UHMWPE (Dyneema ®) | 106.8 |

TABLE 1b
Reference Secure fabric data (containing no metal mesh)
tested in accordance with the HOSDB Slash Resistance Standard
for UK Police (2006), Publication No. 48/05.

| | Force |
|---|---|
| Secure fabric construction | (N) |
| 3 x 180 g/m² layers hydroentangled UHMWPE (Dyneema ®) | 71.8 |
| 1 layer 180 g/m² hydroentangled UHMWPE (Dyneema ®) + | 83.0 |
| 1 layer 160 g/m² needlepunched UHMWPE (Dyneema ®) | |
| 2 x layer 160 g/m² needlepunched UHMWPE (Dyneema ®) | 87.6 |
| 3 x layer 180 g/m² hydroentangled UHMWPE (Dyneema ®) | 125.07 |
| and 150 g/m² hydroentangled para-aramid (Kevlar ®) | |

### EXAMPLE 2

Two carded and cross-lapped webs were prepared from 100% PPTA fibres (para-aramid) and fed either side of a knitted metallic mesh composed of hardened and annealed twin strand filament of 0.28 mm diameter. The first fibrous layer had an area density of 50 g/m² and the second fibrous layer 150 g/m². The knitted metal mesh layer was 1800 g/m² consisting of annealed and hardened 2-strand filament. After prewetting to evacuate air in the fibrous layers, the three layer construct was hydroentangled using 5 injectors with a water jet pressure profile in which the maximum pressure was 220 bar (2.2 MPa). The fabric was dried in a through-air dryer. The cut resistance of the resulting fabrics were tested according to EN388:2003 (6.2 blade cut resistance) and EN ISO 13997:1999 at an independent facility. The blade type used was GRU-GRU 88-0121 and the sharpness was correction factors were 0.839 and 0.822. The samples were found to achieve a level 5 result in accordance with EN388:2003 and found to require a cutting load for a 20 mm cut of 86.7N in accordance with EN ISO 13997:1999—this is equivalent to a level 5 cut resistance in EN 388:2003.

1. A reinforced fibrous material comprising:
a first nonwoven fabric layer and a second nonwoven fabric layer:
a metallic mesh in between the first nonwoven fabric layer and the second fabric layer, the metallic mesh comprising a plurality of openings between solid regions of the metallic mesh;
wherein fibers from the first and second nonwoven fabric layers are entangled with the solid regions of the metallic mesh; and
wherein fibers from the first and second nonwoven fabric layers are entangled to one another within the plurality of openings of the metallic mesh such that the material no longer comprises discrete layers, but diffused entangled layers at least at their interfaces.

2. (canceled)

3. The reinforced fibrous material according to claim 1 wherein the material comprises a nonwoven fabric produced from one or more of continuous filaments or staple fibres.

4. (canceled)

5. The reinforced fibrous material according to claim 1, wherein the first and second nonwoven fabric layers are formed from the same material.

6-9. (canceled)

10. The reinforced fibrous material according to claim 1 wherein each fabric layer has a fabric weight of 20 to 150 gm⁻².

11. The reinforced fibrous material according to claim 1 wherein at least one of the first and second nonwoven fabric layers comprises aramid fibres.

12. The reinforced fibrous material according to claim 11 wherein at least one of the first and second nonwoven fabric layers comprises para-aramid fibres.

13. The reinforced fibrous material according to claim 1 wherein the second nonwoven fabric layer comprises fibers having a lower density than fibers of the first nonwoven fabric layer.

14. The reinforced fibrous material according to claim 1 wherein a length of the fibers used in the first and second nonwoven fabric layers is from 3 to 100 mm.

15. The reinforced fibrous material according to claim 1 wherein the metallic mesh is a metal mesh of woven, knitted or laid-up filament construction.

16. (canceled)

17. The reinforced fibrous material according to claim 15 wherein the metallic mesh comprises a high tensile and annealed steel.

18. (canceled)

19. The reinforced fibrous material according to claim 1 wherein the material comprises polymeric fibers entangled with each other within the plurality of openings of the metallic mesh.

20. The reinforced fibrous material according to claim 1 wherein the diffused fibrous layers comprise entangled aramid fibres.

21-23. (canceled)

24. A method of manufacturing a reinforced fibrous material comprising:
(a) disposing a metallic mesh proximate a first nonwoven fabric layer and a second nonwoven fabric layer, the metallic mesh comprising a plurality of openings between solid regions of the metallic mesh;
(b) entangling fibers of the first nonwoven fabric layer and fibers of the second nonwoven fabric layer with the solid regions of the metallic mesh; and.
(c) entangling fibers of the first nonwoven fabric layer with fibers of the second nonwoven fabric layer within the plurality of openings of the metallic mesh.

25. The method according to claim 24 wherein said steps (b) and (c) of entangling are done by hot fluid jet entanglement.

26. The method according to claim 24 wherein said steps (b) and (c) of entangling are done by mechanical entanglement.

27. The method according to claim 26 wherein the mechanical entanglement comprises needle punching.

28. The method according to claim 26 wherein the mechanical entanglement comprises hydroentanglement.

29. An intrusion resistant roller blind comprising the reinforced fibrous material of claim 1.

30-31. (canceled)

32. An intrusion resistant blind assembly kit comprising an intrusion resistant roller blind according to claim 29, a casing and one or more rails configured for attaching the reinforced fibrous material to the roller blind.

33. (canceled)

34. The reinforced fibrous material according to claim 1, wherein the fibers from the first and second nonwoven fabric layers are entangled with one another or to the metallic mesh in discrete regions of the reinforced fibrous material.
